(19) United States
(12) Patent Application Publication
(10) Pub. No.: US 2008/0117756 A1
(43) Pub. Date: May 22, 2008

(54) Gain Adjusting Method and Apparatus for adjusting the Signal Gain of an Optical Disk Pick-up Signal

(75) Inventors: Antonius Leonardus Johannes Dekker, Eindhoven (NL); Hubertus Wilhelmus Anna Knoors, Born (NL); Theodorus Antonius Engelbertus Langenhuizen, Nuenen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,109

(22) PCT Filed: Jan. 5, 2006
(86) PCT No.: PCT/IB06/50044

§ 371 Date: Jun. 29, 2007

Related U.S. Application Data
(60) Provisional application No. 60/642,806, filed on Jan. 10, 2005.

(51) Int. Cl. G11B 7/00

(52) U.S. Cl. 369/53.12

(57) ABSTRACT

A method and apparatus that compensates for power variations occurring in a beam (11) of reflected light from a laser (10) within optical disc recording devices. Signal multiplication techniques are applied to signals indicative of light reflected from the optical disc. The signal multiplication conditions signal indicative of the reflected light by selecting a gain factor from one of a plurality of possible constants. The constant selected by the gain factor is dependent on the determined state of the device. Factors used in determining the gain factor include of the position of the light spot from the laser is currently passing over written track or passing over unwritten tracks, and whether the laser is currently in a read mode or a write mode. These constants as determined create a gain factor corrected signal that is independent of the state of the optical pick-up. The focus and radial position signals created from gain factor corrected signals are more consistent allowing for focus and radial position controllers that are simpler and more accurate.

The present invention relates optical disc recording devices and, more particularly, to compensating for fluctuations that occur in power of a reflected signal from recordable optical discs.

Optical recording devices employ light spot emitted from lasers to facilitate the exchange of data from and to optical discs through read and write mechanisms. A number of factors alter the amount of laser power that is employed in any given system. During writing cycles, the laser power that is employed is substantially higher than the laser power employed during reading cycles because creating optically detectable indicia on an optical disc requires more power than reading optically detectable indicia. Therefore, the power of the laser beam varies as a function of whether the laser is in a read mode or a write mode. The amount of power contained within the light that is reflected from the optical media is dependent upon the laser power originally contained within the beam the originated from the laser. In addition to the amount of laser power used to generate the beam, the power of the light reflected from the optical media varies as a function of laser position on areas that are written or unwritten. These positional fluctuations occur as the laser move over areas that have already been written compared to unwritten areas that have different reflectivity levels.

The fluctuations in laser power requirements that occur due to recording system being is a read or write mode, or due to position variations in the reflectivity of the disc require different laser power levels. These variations in power levels are more pronounced using different types of discs such as a DVD, CD or BD (Blu-ray Disc). Current optical disc drives have rotational frequencies on the order of about 10,000 rpm. Such high rotational frequencies require very high bandwidths for actuator servos that control tracking and focusing of the optical pick-up. Because of dynamical behavior of the actuator the bandwidth is limited. Detector gain variations cause bandwidth variation. A lower bandwidth results in worse tracking capabilities for the pick-up during periods of disc disturbances and attempts to operate at higher bandwidths can lead to resonant behavior leading to bad tracking.

From the foregoing discussion, it should be apparent that there remains a need within the art for a method and apparatus that can effectively compensate for fluctuations that occur within the power of a reflected signal from recordable optical discs.

This invention addresses the shortcomings within the prior art by providing a method and apparatus that compensates for power variations that occur in reflected laser signals used in recordable optical discs. The invention employs a signal multiplier that conditions detector signals by switching the multiplier to one of a plurality of possible constants. The chosen constant depends on the pick-up state: passing over written track; passing over unwritten tracks; or read or recording. These constants are predetermined in such away that the resulting detection signal after multiplication is independent on the pick-up state. The focus and radial position signals will be more consistent so the focus and radial position controllers can be simpler and/or more accurate. By detecting states that are responsible for detector gain variations, the detector gain can be rectified. Once the gain is rectifies, the variation is reduced and higher bandwidths are possible leading to better capability for focus and tracking of discs.

These and objects of the invention are provided by compensating for power variations within reflected laser signals used in recordable optical discs by directing a beam of light on a surface that has fluctuations in optical reflectivity, detecting a reflected signal from the surface; and employing a signal multiplier that conditions the detected reflected signal by switching a multiplication value of the signal multiplier to one of a plurality of possible constants.

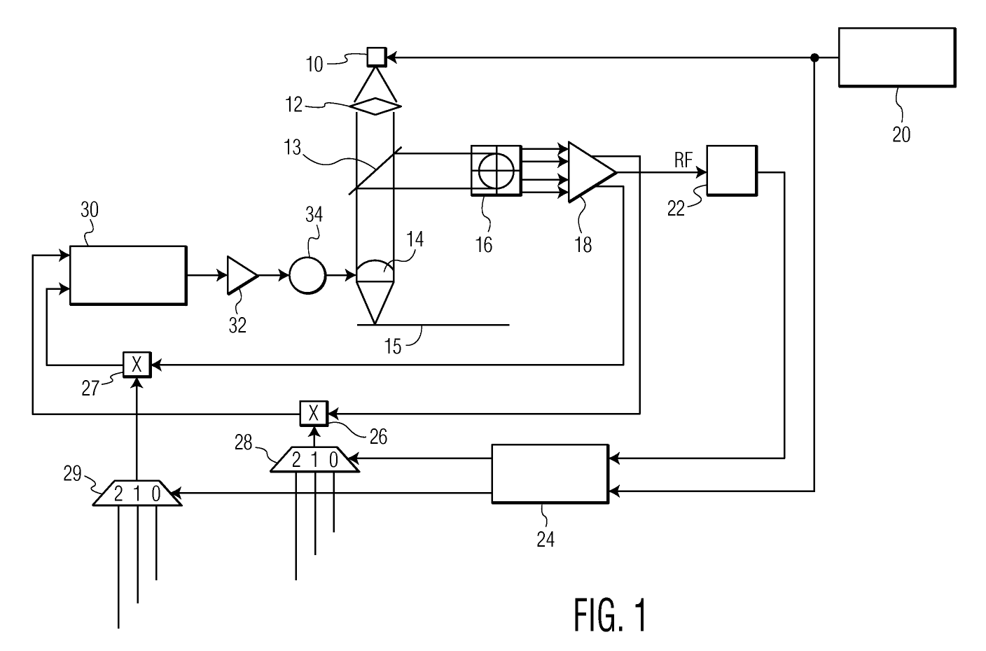

FIG. 1 is a diagram for an optical recording system.

It has been discovered that servo actuators used to control focus and radial tacking within optical disc recording devices can have their bandwidth increased by correcting variations that inherently occur. By detecting states responsible for detector gain variations, the detector gain can be rectified and the variation is reduced allowing for higher bandwidths. By the device being able to operate at higher bandwidths, enhanced focusing and tracking abilities are achieved.

The invention features a gain cell in the detector signal path with a plurality of gain values. Further it comprises a detector that detects the presence of written area on the optical disc. This can be a peak-peak detector with attack and release times, or a signal square block and low-pass filter combination. The gain can be chosen as function of the presence of data and the read/write state of the laser.

The optical pick-up comprises a lens 14 that focuses a beam 11 from laser 10 on the disk by action of focus actuator 34. The lens 14 can also move in radial direction under control of the radial actuator 35. The beam from laser 10 passes through culminating lens 12 and is reflected through prism 13 onto disc 15. A reflection of beam 11 from disc 15 is directed prism 13 and projected on a photodetector 14. Photo detector 14 is preferably a quadrant type photodetector. Each quadrant of photodetector creates a signal indicative of the amount of light that has been reflected from the reflection of beam 11 by disc 15 and has become incident on that quadrant. The signals from each quadrant of the photodetector 14 are received by signal conditioner 18. Signal conditioner 18 performs signal processing on the signal received from photodetector 14 to create radial and focus error signals. The radial and focus error signals generated by signal conditioner 18 are measures of the deviation of the spot created by beam 11 on disc 15 as compared to ideal “on track” and “in focus” positions. Signal conditioner 18 also supplies a signal to written area detector 22 representative of the reflectance of the present disc area that beam 11 is incident upon. Written area detector then determines if the present disc area that beam 11 is incident upon is a written area or an area that as not yet been written to.

The invention envisions that a multiplying factor can be applied to the radial and focus error signals from the signal conditioner 18. The preferred embodiment employs a radial multiplier 27 that multiplies the radial error signal with radial gain 0, 1 or 2 depending on whether the optical pick-up (lens 14 and actuators 34, 35) is reading data, passing over a non-written area or writing data. The focus multiplier 26 multiplies the focus error signal with a focus gain of 0, 1 or 2 depending on whether the pick-up is reading data, passing over non written area or writing data. The decision of the gain that is chosen to be applied multipliers 26, 27 is made by the microcontroller 24, and this gain is referred to herein as the gain multiplication factor. The gain multiplication factor is dependent upon signals input to microcontroller 24 from the laser controller 20 and written area detector 22. The signal that is input to microcontroller 24 from laser controller 20 indicates if the laser 10 is currently in the process of performing a read or write operation. The signal that is input to microcontroller 24 from written area detector 22 indicates if the light sensed by photodetector 14 from the reflection of beam 11 contains a reflection level that is indicative of a written area or an unwritten area. The gain multiplication factor are applied to multipliers 26, 27, which respectively apply the gain multiplication factor to the focus and radial error signals from signal conditioner 18. By implementing gain multiplication factors to the focus and radial error signals, variations within the focus and radial error signals are reduced. The focus and radial error after application of the gain multiplication factor that have these reduced variations are then output from multipliers 26, 27 to the servo controller 30. The output of the servo controller 30 will then receive focus and radial error signals that are more accurate with fewer variations and generates signals to driver amplifiers 32 that are more representative of the area of disc 15 that beam is presently incident upon. The driver amplifiers then supply signals to the focus and radial actuators 34, 35 that provide for more accurate movement of lens 14 in response to the present area upon which light bean 11 is presently incident.

The applications of the invention are especially useful in CD, DVD and BD optical recording systems. Newer disc formats, such as BD, accentuate the problems that are addressed by the invention as discussed above. Accordingly, the preferred embodiments discussed have described the best modes envisioned by the inventors, which are very high speed and high density modern recording systems. It will be readily apparent to those skilled in the art, that the invention as described, herein, has applications that outside of the preferred embodiments described above. Therefore, the scope of the invention should be measured by the appended claims.

1. A method of compensating for power variations within reflected laser light used in recordable optical discs comprising:
directing a beam (11) of light from at least one laser (10) on a surface of an optical disc (15) that has fluctuations in optical reflectivity;
detecting (16) reflected light from the surface and generating (18) at least one signal from detected reflected light; and
employing at least one signal multiplier (26, 27) that conditions the detected reflected signal by switching a multiplication value of the signal multiplier to one of a plurality of possible constants.

2. The method of claim 1 wherein employing further comprises the multiplication value chosen for the constant depends on a state detected within the reflected signal.

3. The method of claim 2 wherein the state is selected from: a written track; an unwritten track; or a recording state.

4. The method of claim 1 wherein the constants are predetermined such that further the resulting detected reflected signal after multiplication is independent of the constant.

5. The method of claim 1 wherein the constant is selected based on a focus criteria.

6. The method of claim 1 wherein the constant is selected based on a tracking criterion.

7. A method for enhancing actuator function on an optical disc recording system comprising:
detecting states responsible for gain variations within an optical detector;
rectifying detector gain; and
applying rectified detector gain to at least one actuator.

8. The method of claim 7 wherein applying further comprises applying to a tracking actuator.

9. The method of claim 7 wherein applying further comprises applying to a focus actuator.

10. The method of claim 7 wherein applying further comprise the at least one actuator operating at a higher bandwidth.

11. A system for compensating in power variations within reflected laser signals used in recordable optical discs comprising:
a laser (10) configured to direct a beam (11) of light through optics upon a disc (15) surface, the disc (15) surface having fluctuations in optical reflectivity;
a detector (16) positioned to receive reflected light from the disc (15) surface and create at least a focus signal or a tracking signal;
a circuit arrangement (24) configured to receive the at least one of the focus signal or the tracking signal and generate therefrom a gain value; and
a gain application circuit that applies the gain value to the at least one of the tracking signal or the focus signal.

12. The system of claim 11 wherein the gain application circuit further comprises the multiplication value chosen for the constant depends on a state detected within the reflected signal.

13. The system of claim 12 wherein the state is selected from: a written track; an unwritten track; or a recording state.

14. The system of claim 11 wherein the constants are predetermined such that further the resulting detected reflected signal after multiplication is independent of the constant.

15. The system of claim 11 wherein the constant is selected based on a focus criteria.

16. The system of claim 11 wherein the constant is selected based on a tracking criterion.

17. The system of claim 11 further comprising at least at least one actuator that receives the gain applied signal.

18. The system of claim 17 wherein the at least one actuator further comprises an actuator related to tracking actuator.

19. The system of claim 17 wherein the at least one actuator further comprises an actuator related focusing.

20. The system of claim 17 wherein the at one actuator that receives the gain applied signal operates at a higher bandwidth than without the gain applied to the signal.
